(19) United States
(12) Patent Application Publication
(10) Pub. No.: US 2026/0356290 A1
(43) Pub. Date: Nov. 12, 2026

(54) REARVIEW ASSEMBLY WITH MODULAR CAMERA CONSTRUCTION

(71) Applicant: Gentex Corporation, Zeeland, MI (US)

(72) Inventors: Robert Steel, Coventry (GB); Ryan Gerlach, Holland, MI (US)

(73) Assignee: Gentex Corporation, Zeeland, MI (US)

(21) Appl. No.: 19/200,990

(22) Filed: May 7, 2025

(51) Int. Cl. B60R 1/26; B60R 1/04; B60R 1/12; H04N 7/18; H04N 23/51; H04N 23/54

(52) U.S. Cl. CPC B60R 1/26; B60R 1/04; H04N 7/183; H04N 23/51; H04N 23/54; B60R 2001/1253

(57) ABSTRACT

A rearview mirror assembly for a vehicle includes a primary housing defining an internal cavity. A glass element is coupled to the primary housing and includes a transflective layer. A camera fixture is coupled to the primary housing and defining a camera module connector configured to couple to and locate a plurality of different but compatible camera modules within the internal cavity.

### FIELD OF THE DISCLOSURE

The present disclosure generally relates to a rearview mirror with a glass element, and more particularly to a rearview mirror with a camera module selectively coupled to the glass element.

### SUMMARY OF THE DISCLOSURE

According to one aspect of the present disclosure, a rearview mirror assembly for a vehicle includes a primary housing defining an internal cavity. A glass element is coupled to the primary housing and includes a transflective layer. A camera fixture is coupled to the primary housing and defines a camera module connector configured to couple to and locate a plurality of different but compatible camera modules within the internal cavity.

According to another aspect of the present disclosure, a rearview mirror assembly for a vehicle includes a primary housing that defines an internal cavity and an opening providing access to the internal cavity. A glass element is coupled to the primary housing. A camera module includes an imager and a primary housing piece. A camera module connector is located proximate the opening and configured to couple to the primary housing piece and locate the imager within the internal cavity.

According to yet another aspect of the present disclosure, a rearview mirror assembly for a vehicle includes a primary housing that defines an internal cavity and an opening providing access to the internal cavity. A glass element is coupled to the primary housing and includes a transflective layer. The primary housing includes one of guide channels or guide rails aligned with the opening and located in the internal cavity that are configured to couple to the other one of guide channels or guide rails of a plurality of different but compatible camera modules within the internal cavity.

The disclosure generally provides a rearview mirror assembly that is configured to accommodate a plurality of different but compatible camera modules or module types post-assembly. In this manner, one of the plurality of compatible camera modules can selectively be installed in the rearview mirror assembly post-assembly such that an associated vehicle can utilize the camera module to monitor activities within a cabin of the vehicle. The rearview mirror assembly may include a camera fixture that is universally and selectively connectable to the plurality of different but compatible camera modules. As such, the present disclosure provides flexibility in which camera modules are utilized with the rearview mirror assembly and further simplifies servicing and replacement of the camera modules.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:

FIG. 1 is a schematic view of a rearview mirror assembly with a camera module connection system that permits selective coupling of a plurality of different but compatible camera modules to a primary housing of the rearview mirror assembly, according to one aspect of the present disclosure;

FIG. 2 is a partially schematic view of one of a plurality of different but compatible camera modules in a camera module connection system, according to one aspect of the present disclosure;

FIG. 3 is an enlarged view of a glass element of a rearview mirror assembly, according to one aspect of the present disclosure;

FIG. 4A is a schematic view of a camera module powering and control arrangement of a first construction for the rearview mirror assembly, according to one aspect of the present disclosure;

FIG. 4B is a schematic view of a camera module powering and control arrangement of a second construction for the rearview mirror assembly, according to one aspect of the present disclosure;

FIG. 4C is a schematic view of a camera module powering and control arrangement of a third construction for the rearview mirror assembly, according to one aspect of the present disclosure;

FIG. 5 is a schematic view of a camera fixture of a first construction that permits selective coupling of a plurality of different but compatible camera modules to a primary housing of the rearview mirror assembly, according to one aspect of the present disclosure;

FIG. 6 is a schematic view of a camera fixture of a second construction that permits selective coupling of a plurality of different but compatible camera modules to a primary housing of the rearview mirror assembly, according to one aspect of the present disclosure;

FIG. 7A is a schematic view of a camera fixture of a third construction that permits selective coupling of a plurality of different but compatible camera modules to a primary housing of the rearview mirror assembly, according to one aspect of the present disclosure; and

FIG. 7B is a perspective view of a camera fixture of the third construction that permits selective coupling of a plurality of different but compatible camera modules to a primary housing of the rearview mirror assembly, according to one aspect of the present disclosure.

### DETAILED DESCRIPTION

The present illustrated embodiments reside primarily in combinations of method steps and apparatus components related to a rearview mirror with a glass element, and more particularly to a rearview mirror with a camera module selectively coupled to the glass element. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

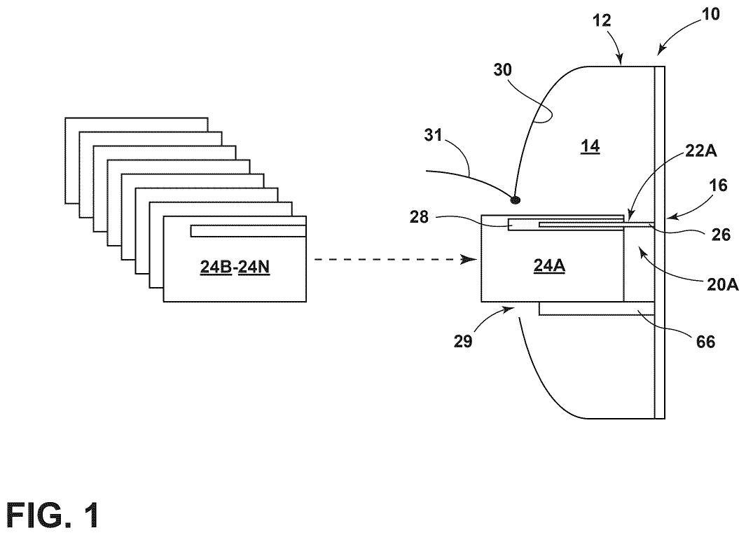

For purposes of description herein, the terms “upper,” “lower,” “right,” “left,” “rear,” “front,” “vertical,” “horizontal,” and derivatives thereof, shall relate to the disclosure as oriented in FIG. 1. Unless stated otherwise, the term “front” shall refer to a surface of the device closest to an intended viewer, and the term “rear” shall refer to a surface of the device furthest from the intended viewer. However, it is to be understood that the disclosure may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

The terms “including,” “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises a.” does not, without more constraints, preclude the existence of additional identical elements in the process, method, article, or apparatus that comprises the element.

Referring to FIGS. 1-3, reference numeral 10 generally designates a rearview mirror assembly 10. The rearview mirror assembly 10 includes a primary housing 12 defining an internal cavity 14. A glass element 16 is coupled to the primary housing 12 and includes a transflective layer 18. A camera fixture 20A is coupled to the primary housing 12 and defining a camera module connector 22A configured to couple to and locate a plurality of different but compatible camera modules 24A-24N within the internal cavity 14.

FIGS. 1-3 depicts a camera fixture 20A and camera module connector 22A of a first construction. As will be described in further detail below, the camera fixture 20A and camera module connector 22A may have a variety of constructions that permit selective coupling of the plurality of different but compatible camera modules 24A-24N. In this manner, the rearview mirror assembly 10 may be preassembled and one of the plurality of different but compatible camera modules 24A-24N may be installed post-assembly. Likewise, once one of the plurality of different but compatible camera modules 24A-24N are coupled to the rearview mirror assembly 10, the installed camera module 24A can be easily replaced and/or serviced by selective removal from the camera fixture 20A and the camera module connector 22A. More particularly, in the first construction, the camera module connector 22A may be configured as one of a guide rail 26 or a guide channel 28 while the plurality of different but compatible camera modules 24A-24N may include the other one of the guide rail 26 or guide channel 28. In this manner, linear movement of the guide rail 26 within the guide channel 28 may facilitate locating and coupling the compatible camera modules 24A-24N within the internal cavity 14. In the depicted arrangement, the camera module connector 22A includes the guide rail 26 and the plurality of different but compatible camera modules 24A-24N includes the guide channel 28. However, it should be appreciated that the guide rail 26 and the guide channel 28 may be switched.

The camera module connector 22A (e.g., the guide rail 26) is depicted as being located in the internal cavity 14. The camera module connector 22A (e.g., the guide rail 26) may be coupled (e.g., directly connected, indirectly connected, or integral with) to an internal surface 30 of the primary housing 12. The guide rail 26 may include one, two, three, four, or more guide rails 26 four insertion into an equal number of guide channels 28 on the camera modules 24A-24N. The guide channels 28 may be located on one, two, three, four, or more different surfaces (e.g., opposing surfaces) for statically positioning the camera module 24A-24N within the primary housing 12. In some implementations, the guide rails 26 and the guide channels 28 may serve as a guide for positioning the camera module 24A-24N and additional fasteners may be used once the camera module 24A-24N is in position. For example, the additional fasteners may include threaded fasteners with corresponding holes in the camera module 24A-24N and the camera fixture 20A, snap-fit connectors that couple upon the camera module 24A-24N being positioned relative to the camera fixture 20A, other mechanical fasteners, adhesives, tapes, and/or the like. The camera fixture 20A may be configured to both guide the positioning of the camera module 24A-24N and statically coupling the camera module 24A-24N once in position.

The primary housing 12 may define an opening 29 (e.g., in a rear surface of the primary housing) that provides access to the internal cavity 14 and the camera fixture 20A. More particularly, the opening 29 may be sized for the insertion of the camera module 24A-24N and connection of the camera module 24A-24N to the camera fixture 20A. The rearview mirror assembly 10 (e.g., the primary housing 12) may further include a cover 31 that mates and otherwise couples to the primary housing 12 and obscures the opening 29. The cover 31 may be pivotally coupled to the primary housing 12, slidably coupled to the primary housing 12, or removable from the primary housing 12. The cover 31 may couple to the primary housing 12 via clips, fasteners, and/or the like.

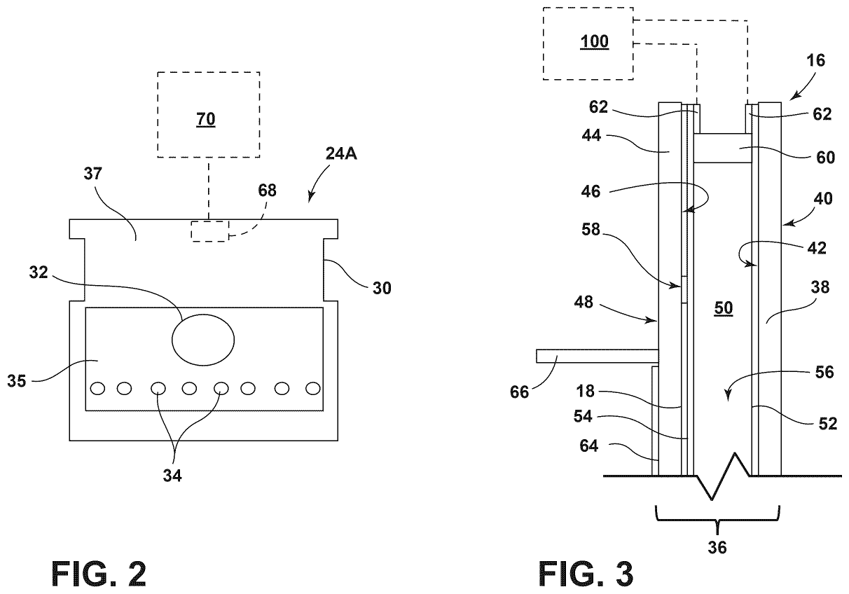

FIG. 2 is a partially schematic view of one of a plurality of different but compatible camera modules 24A (e.g., a first camera module 24A). It should be appreciated that the other camera modules 24B-24N may include the same components as those depicted and described in reference to the first camera module 24A. More particularly, the first camera module 24A may include an imager 32 (e.g., a camera) and one or more light sources 34. The light sources 34 may be configured to generate light that is captured by the imager 32. In some embodiments, the generated light may be in the infrared or near infrared spectrum. In some embodiments, the generated light may be a flood-type light that equally distributes light uniformly in the internal cabin. In some embodiments, the generated light may be patterned, for example, into a plurality of light spots. In some implementations, the plurality of different but compatible camera modules 24A-24N may include an electronic component 35 (e.g., including the imager 32, the light sources 34, and/or control system components) and a housing component 37 that defines the structures for connection to the camera fixture 20A (e.g., the camera module connector 22A) that the electronic component 35 is selectively inserted into. In this manner, the camera fixture 20A (e.g., the camera module connector 22A) may be universal to the housing component 37 of each of the plurality of different but compatible camera modules 24A-24N, while the electronic component 35 may be interchanged. However, it should be appreciated that the electronic component 35 and the housing component 37 may be permanently assembled as a singular piece (i.e., not selectively connectable).

The camera module 24A may be configured to be operably coupled to a control system under a variety of camera module powering and control arrangements that will be described in greater detail below. The operably coupled control system may be configured to monitor the interior cabin for certain conditions. For example, the operably coupled control system may monitor the interior cabin for driver and/or passenger behavior. For example, the operably coupled control system may detect driver and/or passenger behavior associated with drowsiness, seatbelt usage, posture, and/or the like. In some implementations, the operably coupled control system may be configured to extract three-dimensional information. For example, the operably coupled control system may operate under the principles of structured light to extract depth information from the patterned generated light. In some implementations, the operably coupled control system may further be configured to monitor changes in speckle information of one or more of the light spots to detect micro-scale movements. The micro-scale movements may be monitored to identify the presence of occupants and monitor physiological information such as heartbeat and breathing.

With reference now to FIG. 3, an enlarged cross-sectional view of the glass element 16 is depicted. The glass element 16 may include a variety of electrical or electro-optic components for selectively dimming, displaying, and/or generating notifications on or with the rearview mirror assembly 10. The glass element 16 may include an electro-optic device 36. The electro-optic device 36 may include a first substrate 38 having a first surface 40 or viewing surface 40 and a second surface 42. The electro-optic device 36 may further include a second substrate 44 having a third surface 46 and a fourth surface 48. The second substrate 44 is disposed in a substantially spaced apart relationship relative to the first substrate 38 such that the second and third surfaces 42, 46 face one another to define a gap 50. A first electrode 52 is associated with the second surface 42 and a second electrode 54 is associated with the third surface 46. An electro-optic medium 56 is disposed in the gap 50 between the first and second electrodes 52, 54 and configured to switch between one of a high transmissive state, intermediate transmissive states, and a low transmission state (e.g., fully darkened). The camera fixture 20A and camera module connector 22A may be configured to hold the camera module 24A-24B proximate to or against the fourth surface 48.

The transflective layer 18 may be located on or between the fourth surface 48 and the second electrode 54 (e.g., on the third surface 46). The transflective layer 18 may be configured to reflect light at particular polarizations or spectrum ranges. The transflective layer 18 may define an aperture 58 aligned with the imager 32 (e.g., a lens) and opening 29. The transflective layer 18 may be configured to permit the transmission of light in the infrared or near infrared spectrum such that the one or more light sources 34 illuminate through the transflective layer 18 rather than the aperture 58 therein. The electro-optic device 36 may include an outer seal 60 for retaining the electro-optic medium 56 and one or more electrical buses 62 in operable communication with different ones of the first and second electrodes 52, 54. In some implementations, the rearview mirror assembly 10 may include a display 64, which may be configured to generate images associated with image data captured by the imager 32. The electrical components of the rearview mirror assembly 10 (e.g., the glass stack 16, the display 64, audible or notification devices) may receive power and/or instructions via a mirror control system 100 at least partially located on a printed circuit board (“PCB”) 66.

It should be appreciated that the plurality of different but compatible camera modules 24A-24N may include similar connection mechanisms (e.g., guide channels 28 and fasteners) for universal coupling to the camera fixture 20A but may otherwise have one or more different electrical components, lenses, control settings, light sources, and/or the like. For example, the plurality of different but compatible camera modules 24A-24N may have different manufacturers, may be configured for different types of monitoring, utilize different spectrums of light, operate under different principles of visual monitoring, and/or the like.

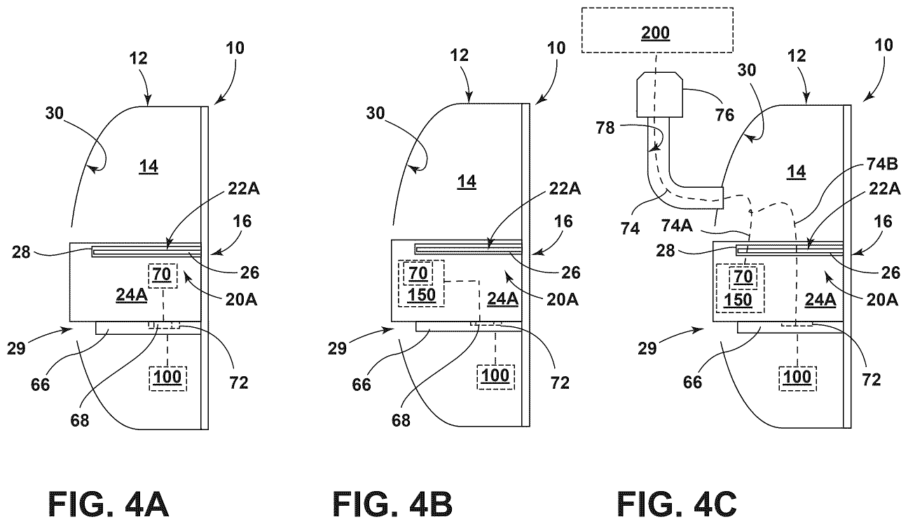

Different constructions of the camera module powering and control arrangements are shown in FIGS. 4A-4C. It should be appreciated that these different constructions of the camera module powering and control arrangements are provided as an example, arrangements other than those depicted and combinations of the different constructions that are depicted may be utilized. The plurality of different but compatible camera modules 24A-24N may include a camera powering terminal 68 that, based on the different arrangements, may power a power circuitry 70 of the camera module 24A-24N. The power circuitry 70 may be part of a designated camera control system 150 that instructs the electrical components (e.g., the imager 32 and light sources) of the plurality of different but compatible camera modules 24A-24N. In such arrangements, the cabin monitoring functionalities may be substantially instructed by the designated camera control system 150. In other arrangements, the camera powering terminal 68 powers the electrical components of the plurality of different but compatible camera modules 24A-24N, but the instructions to the electrical components and the cabin monitoring functionalities may be performed substantially by a separate control system (e.g., the mirror control system 100 or a vehicular control system 200). In still further arrangements, the camera powering terminal 68 powers the electrical components of the plurality of different but compatible camera modules 24A-24N, but the instructions to the electrical components and the cabin monitoring functionalities may be performed substantially by a combination of two or more of the mirror control system 100, the designated camera control system 150, and the vehicular control system 200. In still further arrangements, the camera powering terminal 68 powers the electrical components of the plurality of different but compatible camera modules 24A-24N, but the instructions to the electrical components and the cabin monitoring functionalities may be performed substantially by the vehicular control system 200 that acts as an intermediary between the mirror control system 100 and the designated camera control system 150.

With reference now to FIG. 4A, the depicted camera module powering and control arrangement the PCB 66 includes a socket 72 or matching terminal that becomes operably connected to the camera powering terminal 68 upon installation (e.g., via biasing towards one another with one or more springs). For example, the socket 72 or matching terminal may be configured to automatically interlock into operable communication with the camera powering terminal 68 upon the camera module 24A-24N being inserted into position. In the arrangement in FIG. 4A, the camera powering terminal 68 powers the electrical components of the plurality of different but compatible camera modules 24A-24N, but the instructions to the electrical components and the cabin monitoring functionalities may be performed substantially by the mirror control system 100.

With reference to FIG. 4B, the PCB 66 includes the socket 72 or matching terminal that becomes operably connected to the camera powering terminal 68 upon installation. The camera powering terminal 68 powers the electrical components of the plurality of different. However, the compatible camera modules 24A-24N the cabin monitoring functionalities may be substantially instructed by the designated camera control system 150 that is operably coupled to the power circuitry 70 of the camera module 24A-24N.

With reference now to FIG. 4C, the camera powering terminal 68 is configured to be operably coupled to a flexible electrical connector 74. More particularly, the rearview mirror assembly 10 may include a mounting member 76 configured to attach the rearview mirror assembly 10 to a windshield or overhead space of a vehicle. The mounting member 76 may include a hollow interior 78 configured to at least partially locate the flexible electrical connector 74. The flexible connector 74 may extend to the vehicle control system 200. In some implementations, the flexible connector 74 may be branched opposite the vehicle control system 200 with a first branch 74A coupled to the power circuitry 70 and a second branch 74B coupled to the PCB 66. The flexible connector 74 may facilitate powering the electrical components of the camera modules 24A-24N and the rearview mirror assembly 10. In some implementations, the flexible connector 74 may transmit instructions (e.g., via the vehicle control system 200) to one or more of the electrical components of the camera module 24A-24N and the rearview mirror assembly 10. In still further implementations, the flexible connector 74 operably connects the designated camera control system 150 with the vehicle control system 200 for operable communication of instructions. In some implementations, the flexible connector 74 operably connects two or each of the mirror control system 100, the designated camera control system 150, and/or the vehicle control system 200 for operable communication of instructions.

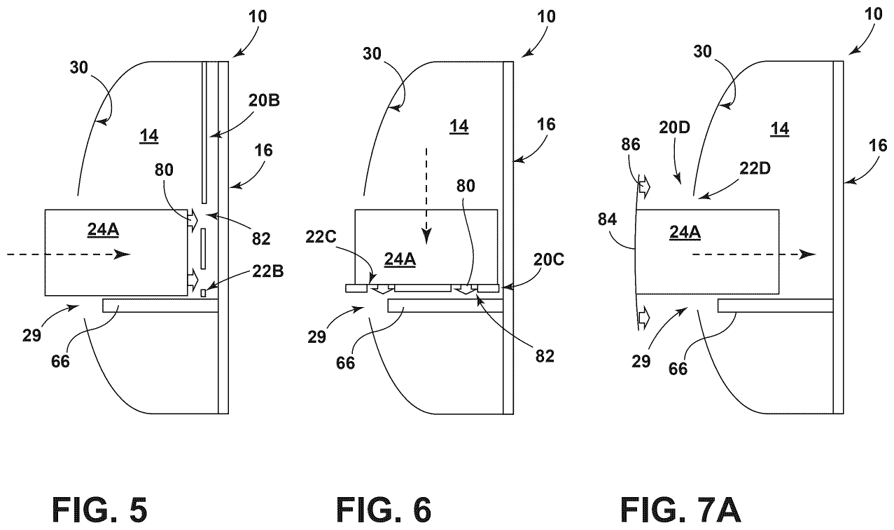

With reference now to FIGS. 5-7B, other constructions of the camera fixtures and the camera module connectors. It should be appreciated that each construction of the camera fixtures and the camera module connectors described herein may be utilized with the various camera module powering and control arrangements depicted in and described in reference to FIGS. 4A-4C. Likewise, each construction of the camera fixtures and the camera module connectors may share the same functionalities, structures, elements, and rearview mirror 10 constructions as each other including those previously described. Likewise, unless otherwise explicitly stated, the various camera fixtures and the camera module connectors may be used separately or in conjunction with one another.

With reference now to FIG. 5, a camera fixture 20B and a camera module connector 22B of a second construction is depicted. In the second construction, one of the camera module connectors 22B and the camera modules 24A-24N defines snap-fit connectors 80 and the other of the camera module connector 22B and the camera modules 24A-24N defines apertures 82 for inserting and retaining the snap-fit connectors 80. In the depicted arrangement, the camera modules 24A-24N define the snap-fit connectors 80 and the camera module connectors 22B define the apertures 82. The snap-fit connectors 80 are depicted as generally facing the glass element 16 and the camera fixture 20B extends along and proximate to the fourth surface 48. In this manner, linear insertion of the camera module 24A-24B into the opening 29 causes coupling between the snap-fit connectors 80 and the apertures 82. The camera fixture 20B and the camera module connector 22B depicted in FIG. 4A and may be utilized in conjunction with the previously described guide rails 26 and guide channels 28.

With reference now to FIG. 6, a camera fixture 20C and a camera module connector 22C of a third construction are depicted. In the third construction, one of the camera module connectors 22C and the camera modules 24A-24N defines snap-fit connectors 80 and the other of the camera module connector 22C and the camera modules 24A-24N defines apertures 82 for inserting and retaining the snap-fit connectors 80. In the depicted arrangement, the camera modules 24A-24N define the snap-fit connectors 80 and the camera module connectors 22C define the apertures 82. The snap-fit connectors 80 are depicted as generally facing transverse from the glass element 16. The camera fixture 20C may extend between a location for accommodating the camera modules 24A-24N and a bottom edge of the primary housing 12. In this manner, linear insertion of the camera module 24A-24B into the opening 29 aligns the snap-fit connectors 80 and the apertures 82, where the camera module 24A-24N can be pressed transversely (e.g., downwardly) to couple the snap-fit connectors 80 to the apertures 82. The camera fixture 20B and the camera module connector 22B depicted in FIG. 4A may be utilized in conjunction with the previously described guide rails 26 and guide channels 28. More particularly, the guide rails 26 may be one or more pins that sit into depressions or branches of the guide channel 28 during the traverse movement of the camera module 24A-24N.

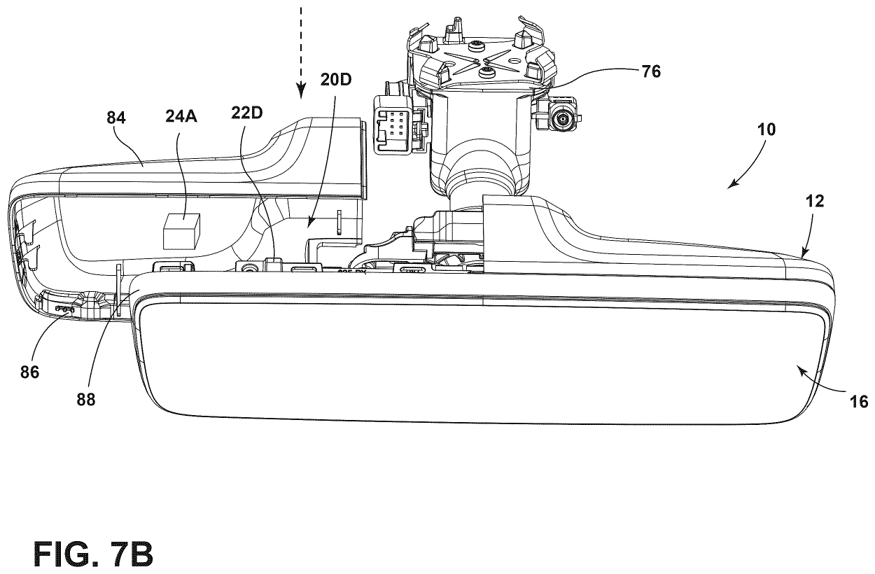

With reference now to FIGS. 7A and 7B, a camera fixture 20D and a camera module connector 22D of a fourth construction is depicted. In the fourth construction, the primary housing 12 defines the opening 29 and the camera fixture 20D includes a plurality of camera module connectors 22D (e.g., clips, snaps, fastener apertures, female connectors, male connectors, and/or the like) circumscribing about the opening 29. The camera modules 24A-24N include a primary housing piece 84. The primary housing piece 84 may be similar to the previously described cover 31 but may be coupled directly to the camera modules 24A-24N. The primary housing piece 84 may include connectors 86, apertures, and/or the like that couple to the camera module connectors 22D. The primary housing piece 84 (e.g., similar to the cover 31) may match a contour of the primary housing 12 such that, when the camera module 24A-24N is installed, the primary housing piece 84 sits flush with the primary housing 12.

As shown in FIG. 7B, the primary housing 12 is depicted as including a bezel 88 that extends around a perimeter of the glass element 16. In some implementations, the bezel 88 defines the camera module connectors 22D and the primary housing piece 84 extends from one of the left or right edges of the bezel 88 to the mounting member 76. However, it should be appreciated that the primary housing piece 84 may have a different size and shape than that depicted in FIG. 7B. For example, a rear surface of the primary housing 12 may define the camera module connectors 22D such that the primary housing piece 84 couples directly to the rear surface rather than the bezel 88 of the primary housing 12. In other implementations, the primary housing piece 84 may couple to the bezel 88 but not extend entirely across a left or right edge of the rearview mirror assembly 10 to the mounting member 76.

With reference now to FIGS. 1-7B, the various constructions described herein may be utilized for post-assembly camera module 24A-24N installation, replacement, and/or servicing. The plurality of different but compatible camera modules 24A-24N may otherwise be described as a plurality of different but compatible camera module types 24A-24N. In other words, while the rearview mirror assembly 10 is configured to accommodate several different types of camera modules 24A-24N (e.g., from different manufacturers), it should be appreciated that two of the same camera module configurations (e.g., the configuration depicted FIG. 2) may be interchanged for servicing and replacement.

The disclosure herein is further summarized in the following paragraphs and is further characterized by combinations of any and all of the various aspects described therein.

According to one aspect of the present disclosure, a rearview mirror assembly for a vehicle includes a primary housing defining an internal cavity. A glass element is coupled to the primary housing and includes a transflective layer. A camera fixture is coupled to the primary housing and defining a camera module connector configured to couple to and locate a plurality of different but compatible camera modules within the internal cavity.

According to another aspect, the camera module connector is located in the internal cavity and the primary housing defines an opening for inserting one of the plurality of different but compatible camera modules into the internal cavity and coupling to the camera module connector.

According to still another aspect, a cover is movable between an open position for exposing the opening and a closed position obscuring the opening.

According to still yet another aspect, a printed circuit board (“PCB”) is statically located in the primary housing and spaced from the camera fixture. The PCB includes a socket configured to electrically couple with the plurality of different but compatible camera modules.

According to another aspect, a mounting member is configured to attach the rearview mirror assembly to a windshield or overhead space of a vehicle. The mounting member includes a hollow interior configured to at least partially locate a flexible electrical connector configured to be coupled to a vehicular control system and the plurality of different but compatible camera modules.

According to still another aspect, the camera module connector is configured to retain the plurality of different but compatible camera modules against a rear surface of the glass element.

According to still yet another aspect, each of the compatible camera modules includes a camera module control system. The camera module control system is configured to receive, from the electrically coupled camera module image data, and review the image data for monitoring vehicle occupant behavior.

According to another aspect, the glass element includes an electro-optic device with an electro-optic medium switchable between a plurality of transmissive states.

According to still another aspect, the primary housing defines a rear surface defining an opening. The camera module connector includes one of a male or female connector proximate the opening.

According to still yet another aspect, the plurality of different but compatible camera modules each include a primary housing piece that couples to the opening and matches a contour of the rear surface.

According to another aspect, the primary housing piece includes a different one of the male or female connector than the primary housing.

According to another aspect of the present disclosure, a rearview mirror assembly for a vehicle includes a primary housing that defines an internal cavity and an opening providing access to the internal cavity. A glass element is coupled to the primary housing. A camera module includes an imager and a primary housing piece. A camera module connector is located proximate the opening and configured to couple to the primary housing piece and locate the imager within the internal cavity.

According to still another aspect, a rearview mirror assembly includes a printed circuit board (“PCB”) statically located in the primary housing and spaced from the camera module, the PCB including a socket operably coupled to a camera powering terminal of the camera module.

According to still yet another aspect, a rearview mirror assembly includes a light source configured to generate structured light in an infrared or near infrared spectrum.

According to another aspect, a control system is configured to receive, from the camera module image data, and review the structured light in the image data for extracting depth information from a cabin of the vehicle.

According to still another aspect, the control system is a camera control system located in the camera module.

According to still yet another aspect, the control system is a vehicular control system spaced from the primary housing and a mounting member is configured to attach the rearview mirror assembly to a windshield or overhead space of a vehicle, wherein the mounting member includes a hollow interior configured to at least partially locate a flexible electrical connector operably coupling the vehicular control system and the camera module.

According to another aspect, the primary housing piece includes a contour that matches a contour of the primary housing.

According to yet another aspect of the present disclosure, a rearview mirror assembly for a vehicle includes a primary housing that defines an internal cavity and an opening providing access to the internal cavity. A glass element is coupled to the primary housing and includes a transflective layer. The primary housing includes one of guide channels or guide rails aligned with the opening and located in the internal cavity that are configured to couple to the other one of guide channels or guide rails of a plurality of different but compatible camera modules within the internal cavity.

According to still another aspect, the transflective layer defines an aperture aligned with the opening.

It will be understood by one having ordinary skill in the art that construction of the described disclosure and other components is not limited to any specific material. Other exemplary embodiments of the disclosure disclosed herein may be formed from a wide variety of materials, unless described otherwise herein.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

It is also important to note that the construction and arrangement of the elements of the disclosure, as shown in the exemplary embodiments, is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts, or elements shown as multiple parts may be integrally formed, the operation of the interfaces may be reversed or otherwise varied, the length or width of the structures and/or members or connector or other elements of the system may be varied, the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes or steps within described processes may be combined with other disclosed processes or steps to form structures within the scope of the present disclosure. The exemplary structures and processes disclosed herein are for illustrative purposes and are not to be construed as limiting.

1. A rearview mirror assembly for a vehicle, the rearview mirror assembly comprising:
a primary housing defining an internal cavity;
a glass element coupled to the primary housing and including a transflective layer; and
a camera fixture coupled to the primary housing and defining a camera module connector configured to couple to and locate a plurality of different but compatible camera modules within the internal cavity, wherein each of the compatible camera modules includes an imager that faces the glass element when the associated compatible camera module is located in the internal cavity.

2. The rearview mirror assembly of claim 1, wherein the camera module connector is located in the internal cavity and the primary housing defines an opening for inserting one of the plurality of different but compatible camera modules into the internal cavity and coupling to the camera module connector.

3. The rearview mirror assembly of claim 2, further including a cover that is coupled to the primary housing and pivotal between an open position for exposing the opening and a closed position obscuring the opening.

4. The rearview mirror assembly of claim 1, further including a printed circuit board (“PCB”) statically located in the primary housing and spaced from the camera fixture, the PCB including a socket configured to electrically couple with the plurality of different but compatible camera modules.

5. The rearview mirror assembly of claim 1, further including a mounting member configured to attach the rearview mirror assembly to a windshield or overhead space of a vehicle, wherein the mounting member includes a hollow interior configured to at least partially locate a flexible electrical connector configured to be coupled to a vehicular control system and the plurality of different but compatible camera modules.

6. The rearview mirror assembly of claim 1, wherein the camera module connector is configured to retain the plurality of different but compatible camera modules against a rear surface of the glass element.

7. The rearview mirror assembly of claim 1, wherein each of the compatible camera modules includes a camera module control system, the camera module control system configured to:
receive, from the electrically coupled camera module image data; and
review the image data for monitoring vehicle occupant behavior.

8. The rearview mirror assembly of claim 1, wherein the glass element includes an electro-optic device with an electro-optic medium switchable between a plurality of transmissive states.

9. The rearview mirror assembly of claim 1, wherein the primary housing defines a rear surface defining an opening, the camera module connector including one of a male or female connector aligned with the opening.

10. The rearview mirror assembly of claim 9, wherein the plurality of different but compatible camera modules each includes a primary housing piece that couples to the opening and matches a contour of the rear surface to form a portion of the rear surface of the primary housing.

11. The rearview mirror assembly of claim 10, wherein the primary housing piece includes a different one of the male or female connector than the primary housing.

12. A rearview mirror assembly for a vehicle, the rearview mirror assembly comprising:
a primary housing defining an internal cavity and an opening providing access to the internal cavity;
a glass element coupled to the primary housing;
a camera module with an imager and a primary housing piece; and
a camera module connector aligned with the opening and configured to couple to the primary housing piece and locate the imager oriented towards the glass element from within the internal cavity.

13. The rearview mirror assembly of claim 12, further including a printed circuit board (“PCB”) statically located in the primary housing and spaced from the camera module, the PCB including a socket operably coupled to a camera powering terminal of the camera module.

14. The rearview mirror assembly of claim 12, wherein the camera module further includes a light source configured to generate structured light in an infrared or near infrared spectrum.

15. The rearview mirror assembly of claim 14, wherein a control system is configured to:
receive, from the camera module image data; and
review the structured light in the image data for extracting depth information from a cabin of the vehicle.

16. The rearview mirror assembly of claim 15, wherein the control system is a camera control system located in the camera module.

17. The rearview mirror assembly of claim 15, wherein the control system is a vehicular control system spaced from the primary housing and a mounting member is configured to attach the rearview mirror assembly to a windshield or overhead space of a vehicle, wherein the mounting member includes a hollow interior configured to at least partially locate a flexible electrical connector operably coupling the vehicular control system and the camera module.

18. The rearview mirror assembly of claim 12, wherein the primary housing piece includes a contour that matches a contour of the primary housing.

19. A rearview mirror assembly for a vehicle, the rearview mirror assembly comprising:
a primary housing defining an internal cavity and an opening providing access to the internal cavity;
a glass element coupled to the primary housing and including a transflective layer; and
one of guide channels or guide rails aligned with the opening and located in the internal cavity and configured to couple to the other one of guide channels or guide rails of a plurality of different but compatible camera modules within the internal cavity, wherein each of the compatible camera modules includes an imager that faces the glass element when the associated compatible camera module is located in the internal cavity.

20. The rearview mirror assembly of claim 19, wherein the transflective layer defines an aperture aligned with the imager of a coupled compatible camera module.
